(19) United States
(12) Patent Application Publication
(10) Pub. No.: US 2020/0323171 A1
(43) Pub. Date: Oct. 15, 2020

(54) AUTOMATED RECREATIONAL DEVICE FOR PETS

(71) Applicant: Ryan Crosby, Oakland, NJ (US)

(72) Inventor: Ryan Crosby, Oakland, NJ (US)

(21) Appl. No.: 16/379,329

(22) Filed: Apr. 9, 2019

(51) Int. Cl. A01K 15/02; A01K 29/00; H04L 29/08

(52) U.S. Cl. CPC A01K 15/025; H04L 67/125; A01K 29/005

(57) ABSTRACT

A system for automatically engaging with an animal, comprising: an automated spool with a motor for retracting a cable, a sensor for determining a current distance of extension of the cable, and non-transitory memory comprising instructions that, when executed by a processor, cause the processor to: determine, via data from the sensor, that the animal has pulled the cable out to a predetermined distance; responsive to determining that the cable is extended to the predetermined distance, increase, via the motor, tension in the cable and pulling the animal toward the automated spool without exceeding a tension determined to be potentially harmful to the animal; determining a new distance, different from the predetermined distance; and iterating the steps of determining that the animal has pulled the cable to a given distance, increasing tension to pull the animal, and determining a new distance different from the given distance.

### FIELD OF INVENTION

This application relates to physical devices for automatically entertaining and exercising a dog or other domesticated animal, and more specifically, a device for automatically extending and retracting a cable with a toy attachment while the pet is pulling upon the toy.

### BACKGROUND

Many pet owners are regrettably forced by work, errands, travel, or other considerations to leave a pet alone in the home for periods of time, causing distress to the pet and preventing the pet from receiving a walk or other physical exercise while the owner is absent. Other pet owners may be present, but due to the size or strength of the animal or diminished physical capacity of the pet owner, be unable to walk the pet or engage in a tug-of-war-like game with the animal without risking a fall or another injury. There is an underserved population of pets and pet owners that would be benefitted from automated systems and devices helping to physically engage with the pet without the human user being required to use solely their own strength or be physically present to engage with the pet.

### SUMMARY OF THE INVENTION

A system for automatically engaging with an animal, is disclosed, comprising an automated spool with a motor for retracting a cable, a sensor for determining a current distance of extension of the cable, and non-transitory memory comprising instructions. The instructions, when executed by a processor, cause the processor to: determine, via data from the sensor, that the animal has pulled the cable out to a predetermined distance; increase, via the motor, tension in the cable and pulling the animal toward the automated spool without exceeding a tension determined to be potentially harmful to the animal; determining a new distance, different from the predetermined distance; and iterating the steps of determining that the animal has pulled the cable to a given distance, increasing tension to pull the animal, and determining a new distance different from the given distance.

A method of engaging with an animal via an automated computing device, comprising: automatically determining, via an electronic sensor, that the animal has pulled a cable out to a predetermined distance from a motorized spool; responsive to determining that the cable is extended to the predetermined distance, automatically causing the motor to increase tension in the cable and pull the animal toward the motorized spool without exceeding a tension determined to be potentially harmful to the animal; automatically determining a new distance, different from the predetermined distance; and iterating the steps of determining that the animal has pulled the cable to a given distance, increasing tension to pull the animal, and determining a new distance different from the given distance.

### BRIEF DESCRIPTION OF THE DRAWINGS

FIG. 1 depicts an automated spool used as a component in both the wall-mounted device and the handheld device described herein;

FIG. 2 depicts a wall mounted tugging device incorporating the spool of FIG. 1;

FIG. 3 depicts a wall mounted device in use by a dog in various positions over a period of time;

FIG. 4 depicts a system of devices enabling remote control over the automated device of FIG. 2;

FIG. 5 depicts a method of entertaining or exercising a pet using the presently described devices;

FIG. 6 depicts a handheld version of the tugging device including the automatic spool system of FIG. 1;

FIG. 7 depicts a possible mobile app interface for configuring and controlling a wall-mounted tugging device remotely; and

FIG. 8 is a high-level block diagram of a representative computing device that may be utilized to implement various features and processes described herein.

### DETAILED DESCRIPTION

In response to the needs of pets and their owners, described above, the presently disclosed devices, systems, and applications may be used to allow owners to exercise and play with their pets both face-to-face and remotely by automatically adjusting the tension, retraction, and extension of a tugging cord that is being pulled on at the other end by a pet. The pet is able to struggle against the tugging device, attempting to pull the cord into an extended position or to resist its retraction, while the owner's physical exertion is diminished or eliminated. Devices described herein include both a wall-mounted tugging machine and a handheld tugging device.

While figures and examples described below focus on the use case of entertaining and exercising a pet dog, other pet animals could benefit from variations of the devices described. For example, slightly different behaviors could be used to play with a pet cat or pet ferret too, focusing more on triggering attention by moving an item as if a prey animal, rather than engaging in a tugging game. Moreover, a much larger, heavy-duty version could be used to exercise much larger animals in a zoo or other setting.

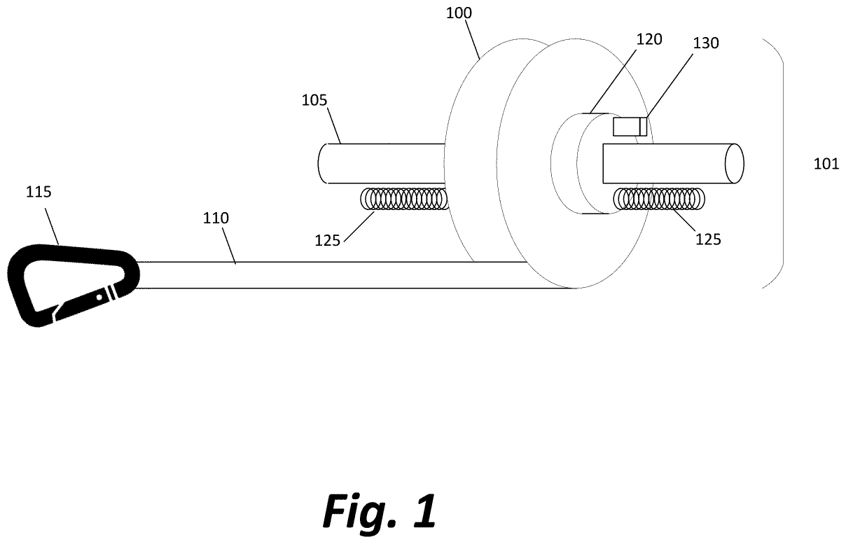

FIG. 1 depicts an automated spool used as a component in both the wall-mounted device and the handheld device described herein.

An automated spool system 101 may comprise a spool 100, axle 105, cable 110, hook 115, retraction means 120, horizontal stabilizers 125, and a controller 130.

Hook 115 may be, in a preferred embodiment, a carabiner that hooks into and then holds securely a loop of a chew toy or other attachment at the end of cable 110. In other embodiments, a simple hook without a more complicated retaining component may be used, or a different principle of attachment may be used, such as a magnetic latch, Velcro, or a male and female corresponding pair of attachments that mechanically lock together. Hook 115 may alternatively be a simple loop through which a hook or carabiner of the attachment passes.

In some embodiments, instead of a hook, a particular attachment (such as a chew toy or ball) may be permanently affixed to the end of the cable 110.

Preferably, axle 105 always remains perpendicular to the ground. Horizontal stabilizers 125 may allow a spool 100 to move left or right along axle 105 without moving to a point too far from a center starting point. The stabilizers 125 may be springs that bias spool 100 toward the center, or padding or washers that cannot move beyond a certain point horizontally, or any other obstacle that provides a slowing or stopping force against spool 100 as the spool gets further from the center of the axle 105.

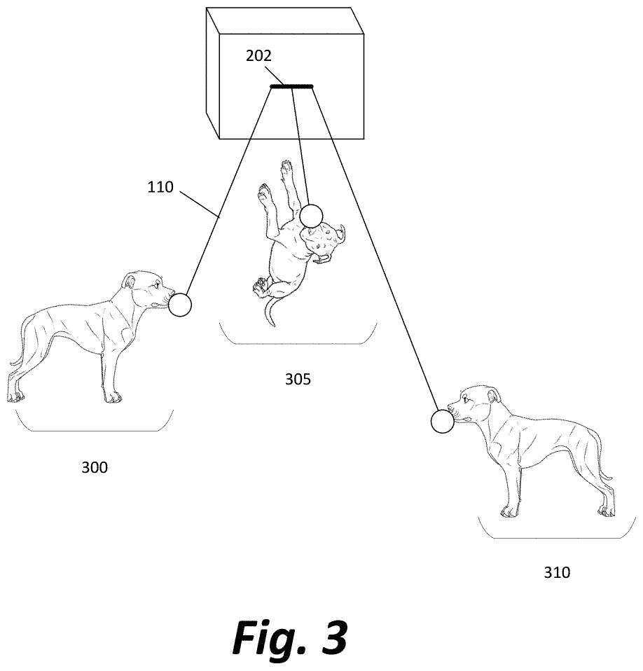

In some embodiments, one or more gimbals may be used at the point where spool 100 is attached to axle 105 in order to allow rotation of the spool not only perpendicular to axle 105, but along a different plane of rotation. For example, as depicted in FIG. 3, below, spool 100 may be permitted to rotate so a dog pulling at three different angles with respect to the axle 105 may nonetheless always be pulling perpendicular to spool 100, which could be rotated towards the dog. This configuration may produce less wear and tear on the cable 110 as cable 110 need not abrade against a lip of spool 100 if it is always pulled out perpendicular to the spool 100.

In a preferred embodiment, cable 110 is made from a durable and relatively inelastic material, such as nylon, paracord, hemp, steel, or aramid fibers. It is preferable that the material be one that would not easily be chewed through by a typical canine's jaws, but also that it be unlikely to damage the canine's teeth if the canine does attempt to chew through. Although nothing prevents a highly elastic material from being used for cable 110, a highly elastic material will make it more difficult for controller 130 to precisely control the tension in cable 110 or the distance that it is capable of being extended through the pet's pulling, and make the tug-of-war game less interesting, less demanding, and less effective at exercising the pet.

In some embodiments, cable 110 may incorporate segmented parts or other rigid augmentations that can fit together to form straight, rigid constructions, allowing cable 110 to be actively pushed out and not only passively waiting for an animal to pull it into an extended position.

Cable 110 may have a substantially circular cross-section or alternatively be a woven strap of fibers that is substantially flat. If a strap is used, spool 100 may incorporate a guiding element, such as a barrier with a slit of similar width to the strap, to ensure that cable 110 lies flat when it is retracted and does not fold over itself or otherwise become tangled around the spool 100.

Retraction means 120 preferably includes a motor that causes cable 110 to spool onto or unspool from the spool 100 when activated. The motor should be strong enough to pull even very large pets, such as a dog of 100 lbs. (or 45 kg.) or more, while also having a variable power that can be finely tuned to only apply a fraction of that force when dealing with a smaller or weaker pet. Retraction means 120 also preferably includes a sensor capable of determining and reporting the current tension in cable 110.

Retraction means 120 may track exactly how far the cable 110 is extended from the spool. This may be accomplished via optical means (for example, an optical sensor that tracks visible marks on the cable 110 as they pass by the sensor, as one might find on a measuring tape) or via mechanical means (for example, tracking a number of rotations of a gear or other rotating part whose radius is known and which physically engages with the cable 110) or any other means. Retraction means 120 may, in alternative embodiments, be unable to determine the distance of extension itself, and instead an external camera (such as a camera 210 described below) may be used to visually determine how far the cable 110 is extended.

Retraction means 120 may have a ratchet and pawl or other hard-stop device capable of engaging to absolutely prevent extension of cable 110 beyond a certain point once engaged, or may simply have the capability via a sufficiently strong motor to ensure that cable 110 cannot be pulled beyond a certain point.

Controller 130 may be a microcontroller, integrated chip, or other computing device capable of receiving a command and in response to the command, causing the retraction means 120 to allow unspooling up to a certain length of cable 110 while maintaining a certain tension, cause retraction and re-spooling of up to a certain length of cable 110 while maintaining a certain tension, or simply to set the tension in the cable 110 to a certain value regardless of whether that is causing a net spooling or un-spooling of the cable. Although in embodiments described below, a second controller generates one of the above commands and communicates them to controller 130, in other embodiments, controller 130 may take on the role of receiving sensor data and making the retraction and extension determinations itself.

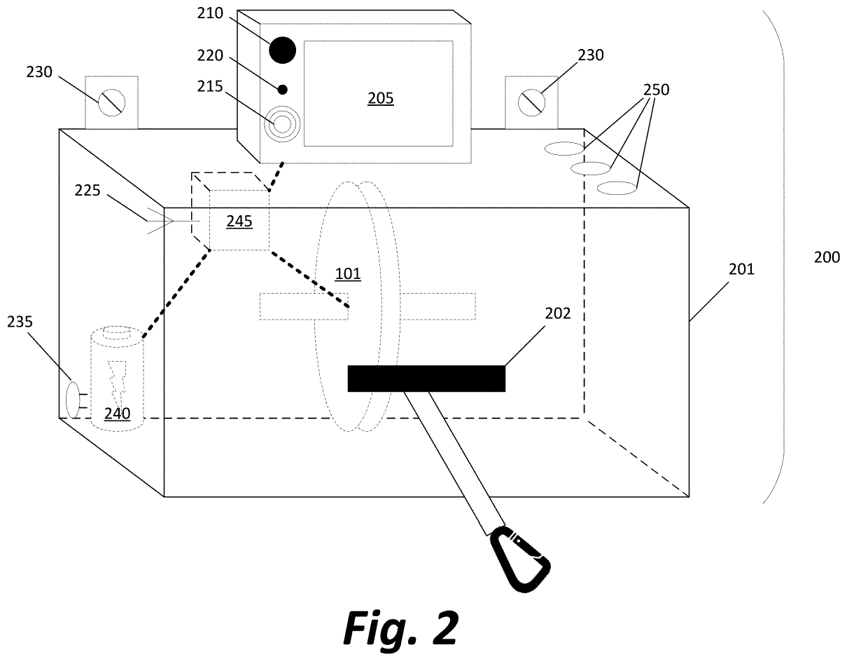

FIG. 2 depicts a wall-mounted tugging device incorporating the automated spool system 101 of FIG. 1.

A wall-mounted system 200 may include, in addition to the automated spool system 101 within a housing 201 (including an external slit-shaped aperture 202), one or more of: a video screen 205, camera 210, speakers 215, microphone 220, wireless or other I/O interface 225, mounting screws 230, charging port 235, battery 240, controller 245, and external controls 250.

Mounting screws 230 are preferably used to permanently affix the wall-mounted system 200 to a wall of a home or other building by screwing into wall studs. In other embodiments, a different method may be used to affix the system 200 to the wall (including nails, straps, etc.,) or system 200 may instead be affixed to another surface, such as a floor or ceiling, or system 200 may in some embodiments (or for certain animals) be sufficiently heavy that no affixing is necessary.

A power system including a battery 240 that is powered by a charging port 235 may be included to power the automated spool system 101 and other components. Charging port 235 may have a built-in power cord that plugs into a power socket of a home or other building, or may be configured to fit a power cord that can be physically separated from the device.

The video screen 205, camera 210, speakers 215, and microphone 220 may be used to establish two-way communication between a remote human user and an animal pulling on an attachment to the automated spool system. It may be preferable to have a panel including the electronics be capable of tilting backwards or forwards, or even capable of folding down, flush with the upper surface of the wall mounted system 200, in order to protect them from damage when not in use. The folding and unfolding may be automatically triggered when the device ends or initializes a tugging game, or when it is powered off and on, respectively.

External controls 250 may be a set of buttons, switches, or other interface elements used to control specific aspects of the system 200's behavior, including, by way of example only, a power button, a control for adjusting a maximum tension, a control for setting a maximum timer for automated play before the system shuts down, and a control for entering a weight of an animal using the system.

Controller 245 is used to communicate with and control the automated spool system 101, causing a random or predetermined pattern of retractions of the cable 110 and permitting extensions of cable 110 when an animal pulls on the cable, according to a method described in further detail below.

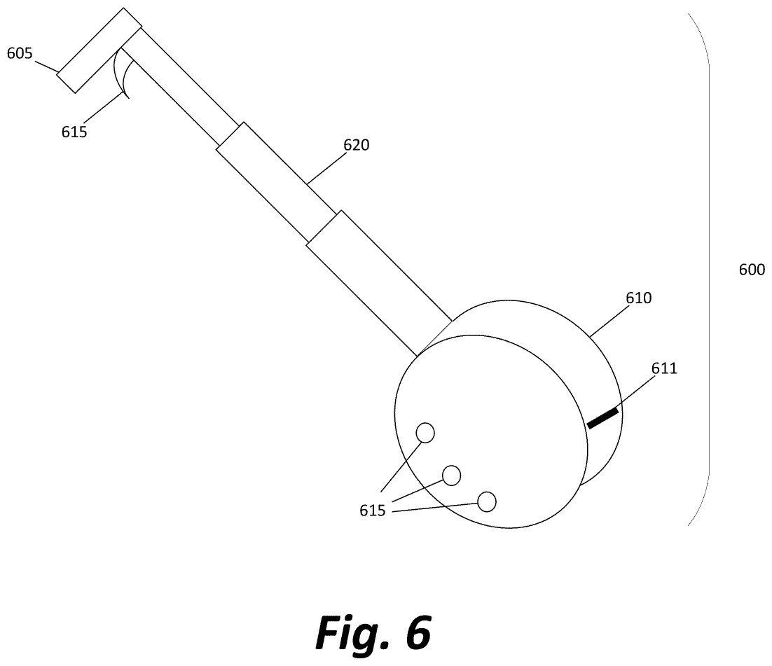

In some embodiments, automated spool system 101 may not be permanently installed in the system 200, but instead may be part of a handheld device, depicted in FIG. 6 and described below. The handheld device may then be installed within the housing 201, plugged into the power system 235 and 240 of the housing, and controlled by controller 245, allowing for animal play without any exertion by the human user. When portability is again desired, the housing 201 may be opened, the handheld device may be removed, and the human user may play a tugging game with an animal remote from the wall-mounted system.

FIG. 3 depicts a wall mounted device in use by a dog in various positions over a period of time.

Initially, a dog may bite down on a ball attachment to the cable 110 and pull it back to position 300. Then, the retraction means may pull the ball and dog in, to position 305. Finally, the retraction means may release sufficient tension to allow the dog to pull the ball out to position 310 before stopping, further than the dog was permitted to pull in the first instance.

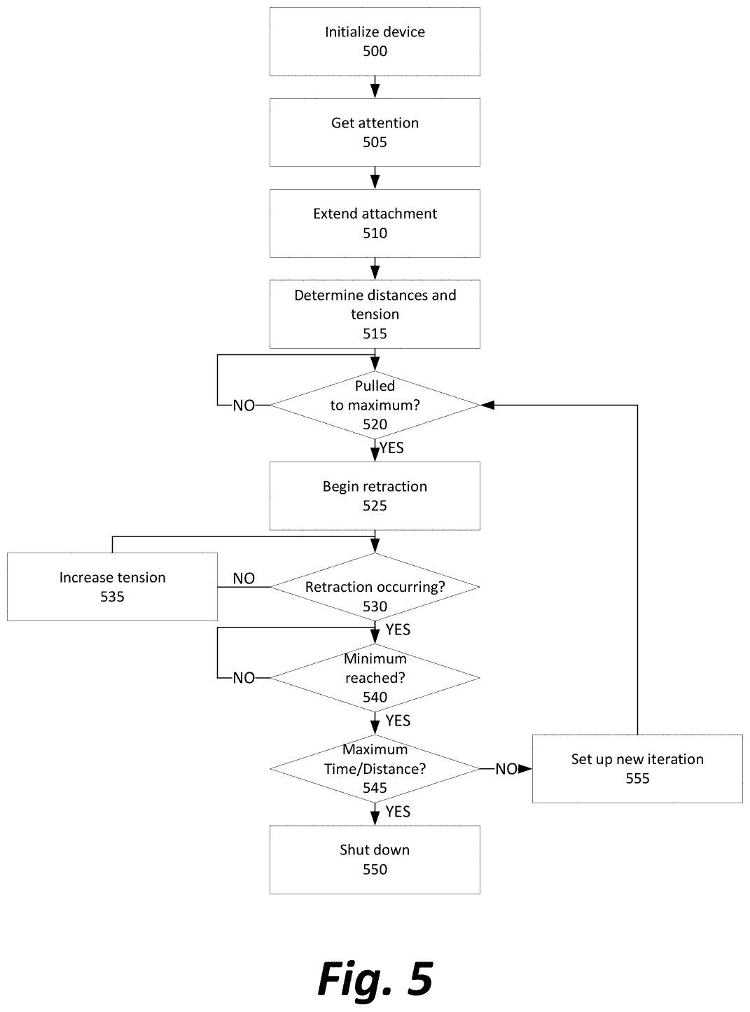

The determination of the positions 300 and 310 that trigger a stop to the extension and begin retraction of the cable 110 to force the dog back, as well as the determination of the position 305 that triggers a release in tension and allows the dog to pull the cable 110 back, are described in further detail during the discussion of FIG. 5, below.

Cable 110 is permitted to swing freely in the lateral direction along slit aperture 202, so that the cable 110 has a minimal amount of friction against the housing of the device 200 during use by the dog, prolonging the life of the cable 110 and avoiding damage to the housing of the device 200.

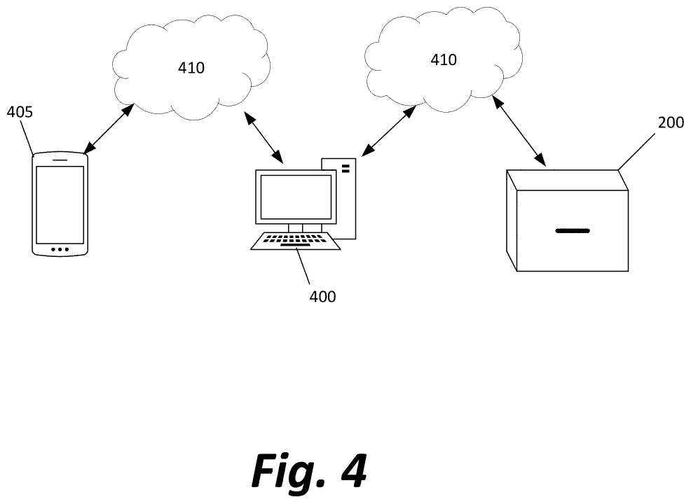

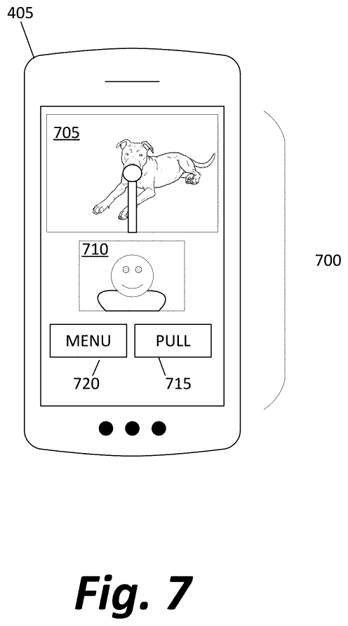

Via means described further below and in FIGS. 4 and 7, a remote human user may be watching the dog's behavior via a camera and visible to the dog via screen 205, encouraging the dog to continue participating in the tugging game as well as providing entertainment or reassurance to the human user that the dog is doing well.

FIG. 4 depicts a system of devices enabling remote control over the automated device of FIG. 2.

At least three devices—wall mounted device 200, intermediate communications server 400, and personal computing device 405—may communicate via one or more networks 410. In most embodiments, networks 410 will be portions of the internet, though in some embodiments, they may be different networks (such as an ethernet or local area wireless network from a home router, if the intermediate communications server 400 or personal computing device 405 are in the same building as the wall mounted device 200) or even be eliminated entirely (for example, if any two devices are in the same home and communicate via Bluetooth, infrared signal, or another data transmission format from one device directly to another.

Personal computing device 405 may be, in a preferred embodiment, a mobile phone capable of downloading and executing applications. In other embodiments, personal computing device 405 may be a personal computer, such as a desktop or laptop; a stationary or handheld gaming console; a smart TV or other home appliance capable of downloading and executing applications, or any other computing device. Personal computing device 405 preferably includes in addition to a video screen for displaying a graphical user interface, a camera, microphone, and speaker, to allow for two-way audiovisual communication.

Intermediate communications server 400 may serve several functions. It may act as a communications bridge and known point to which both personal computing device 405 and wall mounted device 200 should connect, without either needing to know the other's IP address, and allow commands from personal computing device 405 to be forwarded to wall mounted device 200, or for audiovisual data to be forwarded in either direction. Intermediate communications server 400 may also store data on user or pet profiles entered via an application on personal computing device 405. When wall mounted device 200 connects to the intermediate communications server 400, it is then enabled to know characteristics of a pet that may use the device, such as weight and pull strength, so that the wall mounted device 200 may immediately be ready to provide an optimal experience to the pet without building up to a more intense pulling pattern that might injure a smaller pet. User preferences about an intensity of a tugging game, use statistics (such as an estimated number of hours played or of miles traveled while tugging), recorded videos of play sessions, or even pre-recorded messages from an owner to an animal may be stored on intermediate communications server 400.

Data need not necessarily be stored in the intermediate communications server 400 itself, and may in some embodiments be stored in a database outside the physical device and from which the intermediate communications server 400 can retrieve data.

In some embodiments, the functionality described herein for intermediate communications server 400 may be incorporated directly into personal computing device 405 or wall-mounted device 200, and those two devices may be enabled to directly communicate with one another wirelessly without the intermediate communications server. It is also possible, if both devices have an appropriate data port, for a wired connection to be established directly between personal computing device 405 and wall-mounted device 200 if the human user is in the same room.

FIG. 5 depicts a method of entertaining or exercising a pet using the presently described devices.

First, the device is initialized (Step 500). This may involve being expressly activated by a human user, including by a user pressing a physical button or switch of the device, or by receiving a command transmitted from a remote computing device. Alternatively, the device may be initialized by an animal entering a space in front of the device and triggering a motion sensor or being captured on a camera that is perpetually capturing video footage.

The initialization process may include loading information from long-term memory storage in the device or from intermediate communications server 400, such as historical use data or particular configuration files related to a particular animal user of the device. For example, if the human user, during a previous tugging game instance, increased the maximum pull of the device to 30 lbs. of force and indicated that the device should limit the maximum extension to two meters, these settings may be reloaded from memory and applied without the user having to repeat entry.

During the initialization process, a minimum distance may also be set; for example, tension should perhaps end when the end of the cable 110 is 15 cm from the device, so that an animal pulling on the attachment does not slide into the device or injure a nose or mouth with a collision against the device. The minimum distance may also be informed by the presence of any objects near the device, such as a water bowl or feeding bowl with which the animal should not be caused to collide.

In some embodiments, a camera may be used to identify a current animal user of the device during initialization by comparison with a reference image of the animal user from the past, in order to identify one animal user among multiple animals in a single home. Even if a particular animal's identity and the owner's preferred configuration for that animal are not known, camera data may be used to estimate a breed (based on coloring, size, shape, and/or comparison to reference images) and weight (based on breed, height, and girth) and change tension settings or behaviors accordingly. For example, a much more intense pattern of hard pulls may be used for a border collie or pit bull in comparison to a poodle or dachshund, and harder pulls in general may be used on heavier animals.

A camera of the device may be used to make other determinations during initialization. For example, if a human user has placed a protective mat in front of the device to prevent an animal's nails from scratching a floor surface, a controller 245 or 625 may be able to determine from the camera's output the distance to the edge of the mat and adjust a maximum extension distance accordingly. The near presence of a facing wall, furniture, or other obstacle may be used to set a maximum extension length that is not far enough for an animal user to inadvertently collide with the wall or obstacle while attempting to pull on the attachment of cable 110.

After the device is initialized, the device may optionally act to get the animal's attention (Step 505). For example, the spool system 101 may be moved from side to side; an attachment at the end of the cable 110 may receive a command to vibrate or make a noise; the device may produce sound, such as a buzzing, beeping, or a pre-recorded message from a human user encouraging the animal to play; or the device may display an image or video on a video screen or activate other external lights.

Optionally, the device may cause the cable and attachment to enter an extended position, if it has a means of propelling the attachment or making the cable partially rigid in order to be pushed out by the spool (Step 510). This may also serve as a means of getting the animal's attention to initiate the tugging game, if no other method has been employed in Step 505.

Next, the controller 245 (or 625, described below) determines a maximum allowed distance and a retracting tension to be used once the cable is extended by the maximum allowed distance (Step 515).

The maximum allowed distance may be set randomly within a range every time that the determination is performed, or may follow a preprogrammed course. For example, in one embodiment, after determining a maximum distance and minimum distance during initialization as described above, a random value between the distances may be chosen. In another embodiment, a specific pattern of alternating between long and short distances within the range may be followed instead.

The maximum retracting tension may initially be set to a very low value to ensure that the animal is not harmed or taxed beyond its strength, and may be increased over time as the device learns more about the animal's capabilities from the animal's current and past pulling behavior, or even decreased if the animal appears to be tiring and supplying less extending force. A controller 245 or 625 may also be able to estimate a slipperiness of a surface based on camera input (for example, a slipperiness of hardwood floor or linoleum as opposed to carpeting) and adjust a tension needed to force a given animal weight to be pulled in while the animal is standing on that surface.

After setting the maximum distance, the device continually monitors whether the cable has been pulled out to that distance (Step 520). If not, the device continues to wait.

When the distance is reached, the motor of the automatic spool is engaged to begin pulling back at the minimum safe tension determined above (Step 525). The device may be configured to pull until the previously determined minimum distance has been reached, or may determine some distance greater than the minimum distance that should be reached for the present iteration of the tugging game. The device then begins to monitor whether the cable is being successfully retracted, or if instead the animal is overcoming the tension supplied by the motor (Step 530).

If the motor is not successful in overcoming the animal, the maximum allowed tension is gradually increased (Step 535) and the device again determines whether the animal is being pulled in. There may be safeguards in the software controller to set a global maximum tension, or to use a camera or sensor of the attachment to confirm that the animal is still pulling, as opposed to the attachment being caught on furniture or otherwise risking damage or injury if the attachment is forced to move by overwhelming force from the device.

If the motor is successfully pulling in the animal, retraction continues until the minimum distance determined for this iteration is reached (Step 540). The minimum distance for the iteration may be, as described above, complete retraction of the cable 110, or may, for the sake of unpredictability, be a value greater than that.

There may be a maximum time limit or distance traveled configured for a particular tugging game or for all tugging games in general. When this maximum is reached (Step 545), the system may shut down after fully retracting the cable 110 (Step 550).

If the game is to continue, upon reaching the minimum distance for the tugging iteration, the motor decreases tension to allow the animal to begin pulling out the cable and attachment again (Step 555), and repeats the cycle until the game is over.

FIG. 6 depicts a handheld version of the tugging device including the automatic spool system of FIG. 1.

A key advantage of a handheld tugging device is that a handle can be extended downward so that an animal is pulling more laterally than downward, allowing a human user to remain standing and not bend over or struggle with as much risk of falling. In some embodiments, the handheld device may even incorporate a suction cup or adhesive surface to affix a head of the device to the ground and provide additional leverage to the human user against the pulling of the animal.

Handheld device 600 may include handle 605, an automated spool system 101 inside of head 610, external controls 615, an internal accelerometer (not pictured), and (with similar functionality as analogous components in the wall-mounted system 200, and not pictured) a wireless I/O interface, a controller, charging port and battery.

Handle 605 may be connected to the head 610 via a telescoping neck 620 to allow a variable length of the overall device 600, so that human users of differing heights are able to extend the head 610 downward to be roughly at the tugging animal's level and provide a comfortable experience for the human user. In other embodiments, a handle 605 may be attached directly to the head 610 so that the head remains at the human user's hands' level.

Head 610 may include an aperture 611 similar to slit 202 of the wall-mounted model in order to minimize stress on the system if the tugging animal does not tug perpendicular to the handheld device.

Various external controls 615 may be included, such as a power button, buttons to control maximum extension length or tension, or other configuration information. External controls 615 may also include a trigger in the handle 605 that can be used to trigger retraction even if the maximum extension length of an iteration has not yet been reached, giving the human user direct control over the tugging game.

Although a wireless I/O interface is not strictly necessary since the human user is controlling handheld device 600 directly instead of via a remote device's app, it may still connect to intermediate communications server 400 in order to load configuration data about an animal user or to upload usage data for tracking an animal's usage statistics over time.

The controller is used to communicate with and control the automated spool system 101, causing a random or predetermined pattern of retractions of the cable 110 and permitting extensions of cable 110 when an animal pulls on the cable, according to the method described above, with potential limitations on the sophistications of determination if handheld device 600 lacks a camera. The controller may additionally receive data from the internal accelerometer in order to determine whether the human user has dropped the handheld device or the device is experiencing strong lateral movement indicating that the animal is overcoming the human and forcing the human to follow the animal, in which case the tugging game may be terminated until the human user re-initiates the game.

A power system including a battery that is powered by a charging port may be included to power the automated spool system 101 and other components. The charging port may have a built-in power cord that plugs into a power socket in the home or other building; may be configured to fit a power cord that can be physically separated from the device; or may be configured to fit a cord of a wall-mounted device 200 inside which the handheld device 600 may be installed and whose power system it can use.

FIG. 7 depicts a possible mobile application's graphical user interface for configuring and controlling system 200 remotely.

A user interface 700 (displayed by remote computing device 405) may include a first region 705 that shows video captured by camera 210, as well as optionally a second region 710 showing video being recorded by a camera of remote computing device 405.

There may exist a button 715 to activate the system and to manually trigger (similar to trigger 615 of the handheld tugging device) or modify a retraction of cable 110 by increasing or decreasing the tension in the cable 110.

Other menus 720 of user interface 700 may allow a human user to enter animal information such as breed and weight, configure predetermined pulling behaviors to be used instead of random changes in possible pulling distance, or record a message to be played via speakers 215 of system 200.

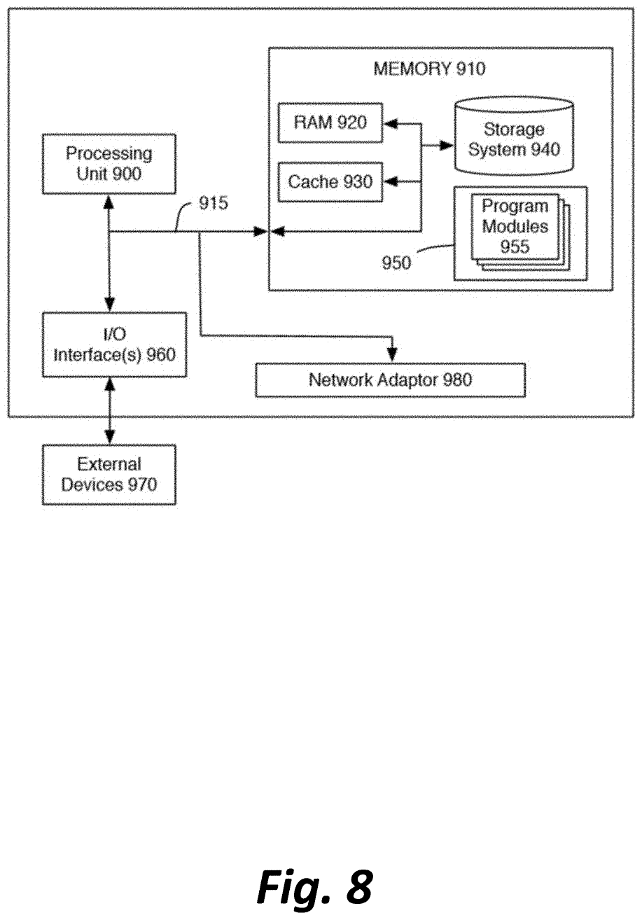

FIG. 8 is a high-level block diagram of a representative computing device that may be utilized to implement various features and processes described herein, including, for example, the functionality of controller 130, controller 245, intermediate communications server 400, and personal computing device 405. The computing device may be described in the general context of computer system-executable instructions, such as program modules, being executed by a computer system. Generally, program modules may include routines, programs, objects, components, logic, data structures, and so on that perform particular tasks or implement particular abstract data types.

As shown in FIG. 8, the computing device is illustrated in the form of a special purpose computer system. The components of the computing device may include (but are not limited to) one or more processors or processing units 900, a system memory 910, and a bus 915 that couples various system components including memory 910 to processor 900.

Bus 915 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Processing unit(s) 900 may execute computer programs stored in memory 910. Any suitable programming language can be used to implement the routines of particular embodiments including C, C++, Java, assembly language, etc. Different programming techniques can be employed such as procedural or object oriented. The routines can execute on a single computing device or multiple computing devices. Further, multiple processors 900 may be used.

The computing device typically includes a variety of computer system readable media. Such media may be any available media that is accessible by the computing device, and it includes both volatile and non-volatile media, removable and non-removable media.

System memory 910 can include computer system readable media in the form of volatile memory, such as random access memory (RAM) 920 and/or cache memory 930. The computing device may further include other removable/non-removable, volatile/non-volatile computer system storage media. By way of example only, storage system 940 can be provided for reading from and writing to a non-removable, non-volatile magnetic media (not shown and typically referred to as a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 915 by one or more data media interfaces. As will be further depicted and described below, memory 910 may include at least one program product having a set (e.g., at least one) of program modules that are configured to carry out the functions of embodiments described in this disclosure.

Program/utility 950, having a set (at least one) of program modules 955, may be stored in memory 910 by way of example, and not limitation, as well as an operating system, one or more application software, other program modules, and program data. Each of the operating system, one or more application programs, other program modules, and program data or some combination thereof, may include an implementation of a networking environment.

The computing device may also communicate with one or more external devices 970 such as a keyboard, a pointing device, a display, etc.; one or more devices that enable a user to interact with the computing device; and/or any devices (e.g., network card, modem, etc.) that enable the computing device to communicate with one or more other computing devices. Such communication can occur via Input/Output (I/O) interface(s) 960.

In addition, as described above, the computing device can communicate with one or more networks, such as a local area network (LAN), a general wide area network (WAN) and/or a public network (e.g., the Internet) via network adaptor 980. As depicted, network adaptor 980 communicates with other components of the computing device via bus 915. It should be understood that although not shown, other hardware and/or software components could be used in conjunction with the computing device. Examples include (but are not limited to) microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may use copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It is understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A system for automatically engaging with an animal, comprising:
an automated spool with a motor for retracting a cable,
a sensor for determining a current distance of extension of the cable, and
non-transitory memory comprising instructions that, when executed by a processor, cause the processor to:
determine, via data from the sensor, that the animal has pulled the cable out to a predetermined distance;
responsive to determining that the cable is extended to the predetermined distance, increase, via the motor, tension in the cable and pull the animal toward the automated spool without exceeding a tension determined to be potentially harmful to the animal;
determine a new distance, different from the predetermined distance; and
iterate the steps of determining that the animal has pulled the cable to a given distance, increasing tension to pull the animal, and determining a new distance different from the given distance.

2. The system of claim 1, wherein the automated spool is mounted on an axle and permitted to move laterally along the axle and parallel to a floor surface.

3. The system of claim 1, wherein the automated spool rotates within a second plane of movement other than a plane perpendicular to an axle passing through the automated spool.

4. The system of claim 1, wherein the automated spool, sensor, non-transitory memory and processor are incorporated within a wall-mounted housing.

5. The system of claim 4, wherein the wall-mounted housing also comprises a wireless communications interface and transmits data to an application on a remote computing device.

6. The system of claim 5, wherein the wall-mounted housing also comprises a camera, and the data comprises a video feed of the animal pulling on the cable.

7. The system of claim 6, wherein the wall-mounted housing also comprises a video screen and speakers, and wherein the video screen and speakers display video and sound from a user of the application on the remote computing device, transmitted to the wireless communications interface.

8. The system of claim 5, wherein the non-transitory memory further comprises instructions that, when executed by a processor, cause the processor to:
receive, via the wireless communications interface and from the remote computing device, a command to increase tension in the cable and pull the animal toward the automated spool; and
responsive to receiving the command, increasing tension in the cable.

9. The system of claim 1, wherein the automated spool, sensor, non-transitory memory and processor are incorporated within a handheld device chassis.

10. The system of claim 9, wherein the handheld device chassis comprises an adjustable-length handle.

11. The system of claim 9, wherein the handheld device chassis is configured to be affixed within, use a power source provided by, and communicate via a wireless communications interface of a wall-mounted housing.

12. The system of claim 1, wherein the determined new distance is randomly chosen within a range of possible values greater than zero and less than the maximum length of the cable.

13. The system of claim 1, wherein the sensor for determining a current distance of extension of the cable is a camera that determines distance from the camera to a point at or near a far end of the cable.

14. The system of claim 1, wherein the sensor for determining a current distance of extension of the cable is an optical sensor at the automated spool that determines distance of extension by reading one or more marks on the cable as it is unspooled.

15. The system of claim 1, wherein the sensor for determining a current distance of extension of the cable determines a number of rotations of a gear or other part that physically engages with the cable and is rotated by extension of the cable.

16. The system of claim 1, wherein the system stores use data regarding a specific identified animal and determines a maximum or minimum tension based at least in part on an identity of the animal pulling the cable.

17. The system of claim 16, wherein the system identifies the animal pulling the cable by use of a camera.

18. A method of engaging with an animal via an automated computing device, comprising:
automatically determining, via an electronic sensor, that the animal has pulled a cable out to a predetermined distance from a motorized spool;
responsive to determining that the cable is extended to the predetermined distance, automatically causing the motor to increase tension in the cable and pull the animal toward the motorized spool without exceeding a tension determined to be potentially harmful to the animal;
automatically determining a new distance, different from the predetermined distance; and
iterating the steps of determining that the animal has pulled the cable to a given distance, increasing tension to pull the animal, and determining a new distance different from the given distance.

19. The method of claim 18, further comprising:
transmitting, to a user of a remote computing device, audio or video data of the animal; and
displaying, to the animal, audio or video data of the user of the remote computing device.

20. The method of claim 18, further comprising:
receiving, from a remote computing device, a command to increase tension in the cable; and
responsive to receiving the command, increasing the tension in the cable.
